(19) United States
(12) Patent Application Publication
(10) Pub. No.: US 2003/0227180 A1
(43) Pub. Date: Dec. 11, 2003

(54) Dual function latch that can be opened using either an axial force directed aginst the latching apparatus normal to the door surface or using a rotational force against the latching apparatus parallel to the door surface

(76) Inventor: Robert C. Tweedt, Ankeny, IA (US)

Correspondence Address: Keats A. Quinalty, Esq., Womble Carlyle Sandridge & Rice, PLLC, P. O. Box 7037, Atlanta, GA, 30357-0037, US

(21) Appl. No.: 10/170,011

(22) Filed: Jun. 11, 2002

(51) Int. Cl. E05B 3/00

(52) U.S. Cl. 292/336.3

(57) ABSTRACT

A door latch assembly configured to maintain an openable door in a closed position using a nose portion interacting with a striker plate, the latch assembly configured for opening the door through either moving the nose portion in response to a force in a plane substantially parallel to the door surface or by retracting the nose portion in response to a force substantially normal to the door surface. Such a dual function latching assembly provides a user with the option to either open the door by exerting a force on the latch assembly substantially normal to the door surface or by turning the latch assembly by exerting a rotating force against the matching assembly in a plane substantially parallel to the door surface.

### FIELD OF THE INVENTION

The invention relates generally to door latches. More specifically, the invention relates to a dual functioning latching apparatus that can maintain a door in a closed position through the interaction between a nose on the latch with a striker plate. The latch of the invention provides a user with options for disengaging the latch with the door frame permitting the user to operate the latch and door in a variety of ways. More specifically, the invention relates to a door latch for a all season door such as a storm or screen door used in conjunction with a main entry door installation. Such a latch can be installed on the surface of the door and can maintain the screen door in a closed position. Such all season doors, storm doors or screen doors are typically manufactured of thinner material than common entry doors and can comprise windows, insulating systems, gaskets, closure systems and other elements common to screen doors or storm doors in conjunction with the dual function latch of the invention.

### BACKGROUND OF THE INVENTION

Door latching apparatus has been a rapidly evolving technology for use in primary entry doors and secondary doors such as all season doors doors. The primary function of the door latch, or catch, is to maintain a door in a closed position when not in use by engaging a strike plate. The door latch however, should respond to the application of a force that moves the latch in such a way to disengage the strike to open the door easily. Once the force is released, the latch should maintain a secure and safe closure, even when the latch is not locked.

Although door latches are known and generally function adequately for their intended purposes, some problems remain. One problem stems from the fact that door latches typically operate in a limited and specific manner. For example, some prior art latches operate in response to rotational forces applied to a handle. Others operate when a user pushes on a handle. Naturally, a user can become accustomed to a certain type of latch mechanism after repeated use. A broad array of closure systems have been used in configuring all season doors, storm doors or screen doors over the years. Simple closures have been used such as simple hook and eye closure systems, spring loaded compression systems and with simple hardware systems. Many screen doors are not latched at all and simply are maintained in a closed position with a spring loaded device that closes the door after its operation. Certain all season doors have been manufactured using either a latch that has an opening by pressing on a lever arm that disengages the latch nose from the strike. Still other doors have latch mechanisms that rotate to withdraw the latch nose from the strike thus permitting the operation of the door. Many users become familiar with one or the other mode of operating of the door and can often be confused when confronted with a door having an unfamiliar operating mode. Such problems can be minor annoyances, however, they can also provide safety concerns if rapid exiting of a location in the presence of some hazard is required.

Further, encounters with non-familiar types of latches can be awkward, especially for elderly users. In situations where a user has a limited range of motion in their wrists or hands, it may become necessary to install a new latch that is better suited to the user's physical capabilities. In nursing home environments, it would not be feasible to replace each latch to accommodate a specific user. Accordingly, a latch system capable of accommodating a broader range of user preferences and physical capabilities is desirable.

Miller U.S. Pat. No. 4,632,439 shows an adjustable latch system that is operated by either compressing a button in a door handle or by compressing a lever arm on the interior of the door to operate the latch nose. This system is representative of conventional systems typically using a force normal to the surface of the door operating either a lever arm or a compression button. Certain handle mechanisms in the prior art are configured such that the handle can move in both a rotation mode and in a normal mode with respect to the surface of the mounting surface. However, in all of these systems, such handles do not operate to open or close a door system when operated in both a rotational and a normal force mode. Examples of these types of handles are shown in Nehls U.S. Pat. No. 2,141,659; Dickason U.S. Pat. No. 2,278,534; Sanderlin et al. U.S. Pat. No. 2,605,648; and Mayer U.S. Pat. No. 1,684,499. Fujiya U.S. Pat. No. 4,480,451 shows a rotational latch having an interior lock operable using a handle that can move in more than one direction. Lastly Butterfield et al. U.S. Pat. No. 4,072,331 shows a “three-way” actuation means. This actuation means provides a variety of operating levers that can be used to operate the door. No one lever has the capability of permitting operation of the door with the operation of the handle in both a rotational and axial mode.

### SUMMARY OF THE INVENTION

The present invention is directed to a dual functioning latching apparatus that can maintain a door, preferably an all season door, in a closed position through the interaction of a latch nose with a striker plate. A user can apply a number of different forces to the latch handle to disengage the nose from the striker plate. In a rotational function of the latching apparatus, the user may apply a force to move the handle in a rotational fashion in a plane that is substantially parallel to the door surface to retract the latch nose. The latching apparatus is also configured such that the user at his option can apply an axial force to the handle that is substantially normal to the door surface so that one end of the handle moves toward the door to retract the latch nose. This dual function latching assembly provides a user with the option of either opening the door by exerting a force on the latch assembly substantially normal to the door surface or by exerting a rotational force against the matching assembly in a plane substantially parallel to the door surface.

With regard to the rotational function of the latching apparatus, the rotational movement of the handle corresponds to the rotational movement of the latch nose about the access of the spindle. In the first position, the latch nose can contact a strike on the door frame. The rotation of the handle in either a clockwise or counterclockwise motion rotates the latch nose to a position that is away from the strike so a user can open the door. When the user is not applying a force to the handle, a turning axis spring can return the handle and latch nose to the first position.

The retractional function of the latching apparatus functions independently of the rotational function. For example, the user can open the door by applying a force in a direction substantially normal to the door surface. In one embodiment, a first spring biases the handle in an extended position. The user can depress the handle on the latching apparatus. This action displaces the handle so that it no longer contacts the latch nose. The displacement of the handle enables the latch nose to pivot toward the spindle and away from the strike on the doorframe. This pivoting action is caused by a second spring that is fastened to the latch nose and the spindle assembly. The second spring biases the latch nose away from the strike on the doorframe. When the user is not applying a force to the handle, the first spring can return the handle to the extended position and overcome the force of the second spring to displace the latch nose to its extended position.

In an alternative embodiment, the latch assembly includes a locking lever. The locking lever has a locked position and an unlocked position operatively connected to the spindle/handle assembly. The lock lever is configured for contacting a corresponding feature on the spindle to substantially prevent axial or rotational movement of the spindle. Similarly, the lock lever is also configured to contact the latch nose when the lock lever is in the locked position. The contact between the lock lever and the latch nose prevents the latch nose from moving toward the spindle and clearing the strike on the doorframe. For the purpose of this patent application, the term “strike” refers to a mechanical element installed on a door frame that can interact with the latch nose of the latch of the invention to maintain the door in a closed position. Strikes are commonly simple planar metal elements having a curved surface to facilitate the engagement and disengagement of the latch nose with the strike surface. For the purpose of this patent application the term “to detract the latch nose from the strike” typically implies that the latch nose is removed from an engaging position with respect to the strike either through a rotational force placed on the handle or through a axial force placed on the handle in a direction normal to the surface of the door. In this application, the term “axial force” relates to a force directed in parallel to the axis of rotation of the latch and acts unlatch in a direction towards the surface of the door. The term “all season door” refers to a door used in conjunction with a main entry door and can be a storm door a screen door or other door that provides added insulation, insect resistance, ease of use, air circulation or other feature in an opening having a entry door.

The above summary of the present invention is not intended to describe each disclosed embodiment or every implementation of the present invention. The figures and the detailed description that follows exemplify these embodiments more particularly.

### BRIEF DESCRIPTION OF THE DRAWINGS

The invention may be more completely understood in consideration of the following detailed description of various embodiments of the invention in connection with the accompanying drawings, wherein like numerals represent like parts throughout several views, in which:

FIG. 1 is a partially exploded front view of a latch assembly of the present invention;

FIG. 2 is an exploded front view of the head and spindle assembly of the present invention;

FIG. 3 is an exploded front view of the base assembly of the present invention;

FIG. 4 is a front view of the turning axis hub of the present invention;

FIG. 5 is a side view of the turning axis hub of the present invention;

FIG. 6 is a side view of the latch nose of the present invention;

FIG. 7 is a front view of the latch nose of the present invention;

FIG. 8 is a top view of the latch base of the present invention;

FIG. 9 is a side view of the latch base of the present invention;

FIG. 10 is a bottom view of the latch base of the present invention;

FIG. 11 is a front view of the stator of the present invention;

FIG. 12 is a top view of the spindle head of the present invention;

FIG. 13 is a side view of the spindle head of the present invention;

FIG. 14 is a front view of the spindle head of the present invention;

FIG. 15 is a front view illustrating handle positions when a push force is applied to the latch assembly of the present invention;

FIG. 16 is a side view illustrating the handle positions when a twist force is applied to the latch assembly of the present invention;

While the invention is amenable to various modifications in alternative forms, the specifics thereof have been shown by way of example in the drawings and will be described in detail. The intention is not limited to the particular embodiments described. On the contrary, the intention is to cover all modifications, equivalents, and alternatives falling within the spirit and scope of the invention.

### DETAILED DESCRIPTION OF THE PREFERRED EMBODIMENT

The door latch apparatus of the invention is configured to maintain a hinged door in a closed position by engaging a strike. The latching apparatus is capable of being mounted on the surface of the door comprising a latch nose and a handle. The latching apparatus is configured such that the user can disengage the latch in either of two different operating modes. First the latch can be disengaged from the strike by the application of rotational force in a plane parallel to the surface of the door. As the handle is moved in that rotational direction, the latch nose is moved away from the strike to disengage the strike permitting the user to operate the door to an open position. The latch also has the capability of being operated in a substantially different mode for a user that expects to be able to operate the door in a different mode. In this mode, the user compresses the handle by placing an axial force on the handle directed towards the surface of the door in a direction normal to the door. As the handle is compressed by this axial force, the handle is coupled with the latch nose through a lever and spring mechanism in a way such that the nose is retracted from the strike. As the operator continues to press the handle in this mode, the door can be operated to an open position. In this way, the latch mechanism of the invention provides a dual operating function in which the dual operating mode can permit a user to operate the door in both common operating modes. The nose, handle, strike, spindle, mounting materials, fasteners and other component parts can be made of conventional structural materials. Commercially available metals, thermoplastics, composites and coatings can be used in the manufacture of the functional unit of the claims.

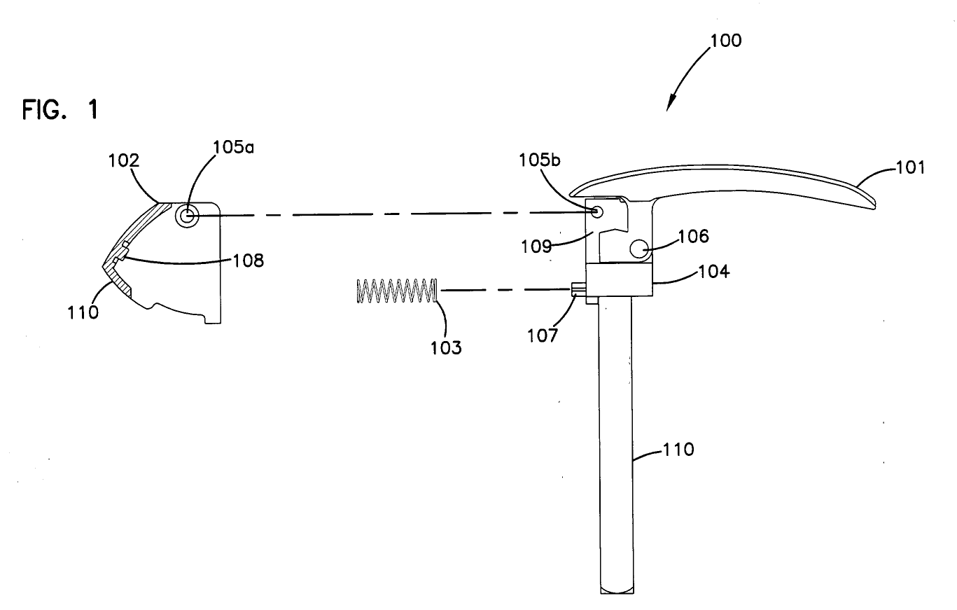

Referring to the drawings, wherein like reference numerals refer to like parts throughout the several views, FIG. 1 shows a partially exploded view of a latch assembly 100 of the present invention. The handle 101 is shown as a substantially elongated member with a first end that is not in contact with the spindle head 109 and a second end that contacts the spindle head 109 at pivot 106. The portion of handle 101 contacting the pivot 106 may have an aperture. The aperture on the handle 101 can be a variety of dimensions. In a preferred embodiment, the diameter of the aperture is at least 0.1 inches (2.5 mm). This dimension permits a fastener to pass through the aperture and the pivot that is a sufficient size and strength to withstand the force of a user opening the door 122.

The handle 101, latch nose 102, spindle head 109, and spindle 110 can be manufactured from a variety of materials including wood, metal, or thermoplastics. In any case, the material should be rigid enough to resist deformation and strong enough to withstand repeated forces from several directions under a variety of operating conditions. Handle 101 can comprise a variety of shapes based on the user's physical capabilities and aesthetic preferences. However, it is desirable to select a handle 101 that is long enough to move the latch nose 102 with relatively little effort. In most cases, handle 101 will be at least 2.5 inches (6.4 cm.) long, although in some embodiments, handle 101 can be up to 5 inches (12.7 cm.) long. Handle 101 can be straight or curved, and have a variety of cross sectional profiles based on the aesthetic preferences of the user. The cross-sectional area of handle 101 should preferably be rigid enough to withstand a variety of forces from several directions. In a preferred embodiment, the cross sectional area of handle 101 should be at least 0.04 in² (0.26 cm²).

Spindle 110 can be slidably inserted into spindle head 109 at housing 104. Spindle 110 can comprise a variety of shapes and dimensional configurations depending upon the thickness of the door 122 and the housing 104. Spindle 110 can have a substantially elongated shape, with a substantially square cross-sectional profile. Spindle 110 should be able to withstand the repeated torque applied by a user against torsion spring 132. In a preferred embodiment, spindle 110 should be at least 2 inches (5 cm) long and have a cross sectional area of at least 0.097 in² (0.62 cm²). Spindle 110 is preferably fabricated from a metallic or thermoplastic material.

Spindle 110 can then be secured to housing 104 using a variety of methods. In a preferred embodiment, a pin 107 extends through slot 113 in the side of housing 104 and into spindle recess 112. The interaction of pin 107 and slot 113 secures spindle 110 into housing 104 so that spindle 110 cannot exit housing 104, or rotate relative to housing 104. In an alternative embodiment, spindle 110 can be secured into housing 104 with a press fit between the spindle head 109 and housing 104.

Latch nose 102 may be rotatably fastened to spindle head 109 at rivet aperture 105b on spindle head 109 and rivet aperture 105a on latch nose 102. Once rivet apertures 105a and 105b are properly aligned, a rivet or other suitable fastener may be inserted through rivet apertures 105a and 105b to rotatably secure the latch nose 102 to the spindle head 109. Rivet aperture 105 may be located in multiple locations, with a variety of dimensions. It is desirable for rivet aperture 105a to be large enough to permit a fastener of suitable strength to pass therethrough. In a preferred embodiment, rivet aperture 105a can have a diameter of 0.125 inches (3.2 mm). The diameter of rivet aperture 105b should be large enough to correspond to the dimension of rivet aperture 105a. In the preferred embodiment, rivet aperture 105b can have a diameter as small as 0.1 inches (2.5 mm).

Latch nose 102 has surface 111 suitably arranged for contacting a corresponding strike 124 extending from a doorframe 123. Surface 111 is preferably at least 45° relative to the surface of the door frame. Surface 111 and strike 124 should be manufactured from a material that is wear resistant. In a preferred embodiment, the surface 111 on the latch nose 102 is biased toward the spindle 110 by a spring 103. The spring 103 may be secured to the latch nose 102 by a stud 108 located on the interior surface of latch nose 102. Stud 108 can be molded from the same material as latch nose 102. The size of stud 108 can vary depending on the size of spring 103. For example, stud 108 may be 0.126 inches (3.2 mm) in diameter.

Spring 103 may be secured to the spindle head 109 or housing 104 by attaching the spring 103 to the end of the pin 107 that is protruding from the housing 104. When a user is not applying a force to the handle 101 the handle 101 is in an extended position (shown in FIG. 1). When a user is applying a force to the handle 101 that is normal to the surface of the door, the handle 101 is in a retracted position (shown with dashed lines in FIG. 15). A pivot spring may be located at pivot 106 that biases the handle 101 in an extended position. Handle 101 and latch nose 102 are rigidly in contact with one another when handle 101 is in an extended position. When a user applies a force normal to handle 101 such that handle 101 moves to a retracted position, latch nose 102 is permitted to rotate towards spindle 110 due to the force of spring 103. When the force normal to handle 101 is no longer applied, the pivot spring should be strong enough to overcome the force of spring 103 acting on latch nose 102 and return the handle 101 to the extended position.

In an alternative embodiment, the spring 103 may be secured to the latch nose 102 by inserting the first end of spring 103 over a stud 108 located on the interior surface of latch nose 102. The interior diameter of the first end of spring 103 and stud 108 can be configured to create a tight fit. Similarly, the spring 103 may be secured to the spindle head 109 or housing 104 by inserting the second end of spring 103 over the end of the pin 107 that is protruding from the housing 104.

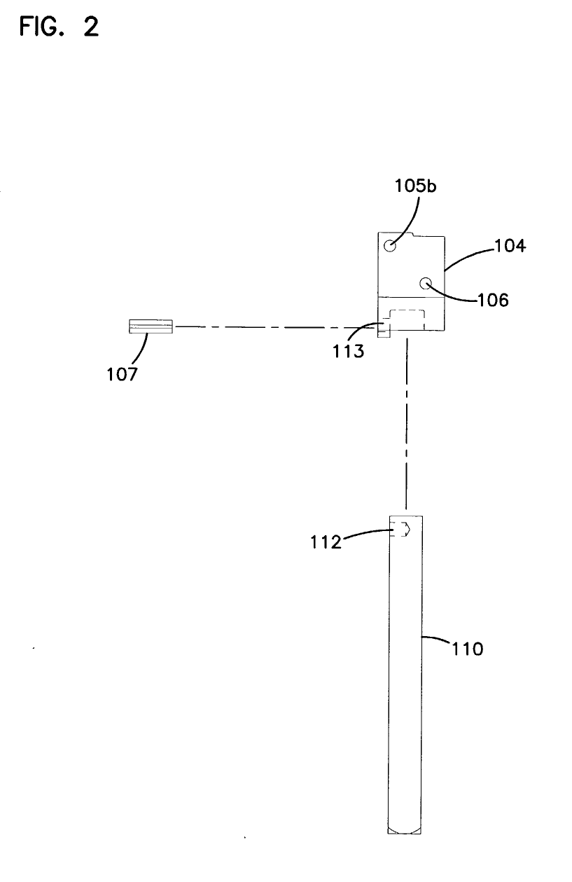

With reference to FIG. 2, the spindle 110 to spindle head 109 assembly is shown with dashed lines representing hidden features in the corresponding parts. For example, spindle recess 112 is shown on spindle 110. Spindle 110 can be inserted into housing recess 114 on spindle head 109. Housing recess 114 is configured so that when spindle 110 is inserted into the housing recess 114, spindle recess 112 aligns with slot 113 on the spindle head 109. Spring pin 107 can then be inserted into slot 113 and spindle recess 112, which locks spindle 110 into housing recess 114. It should be appreciated that the spindle 110 to spindle head 109 assemblies can comprise many different embodiments while falling within the scope of this invention. For example, the spindle recess 112 can consist of a drilled hole in the side of the spindle 110, or it could consist of a milled groove running the entire circumference of spindle 110. In an alternative embodiment, spindle 110 would not contain a spindle recess 112. In that situation, spindle 110 could be press fit into housing recess 114 or secured in place with the friction of spring pin 107 inserted into slot 113. In a preferred embodiment, spindle recess 112 is at least 0.15 inches (3.8 mm) deep and at least 0.12 inches (3.0 mm) in diameter. The center of spindle recess 112 can preferably be located at least 0.12 inches 3.0 mm from one end of the spindle 110.

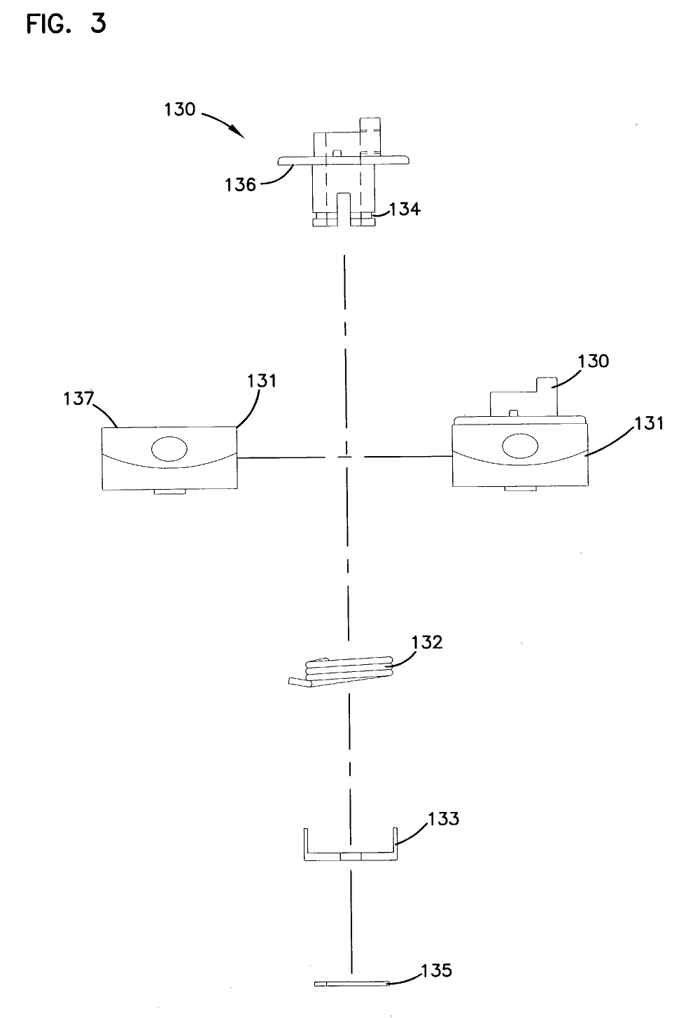

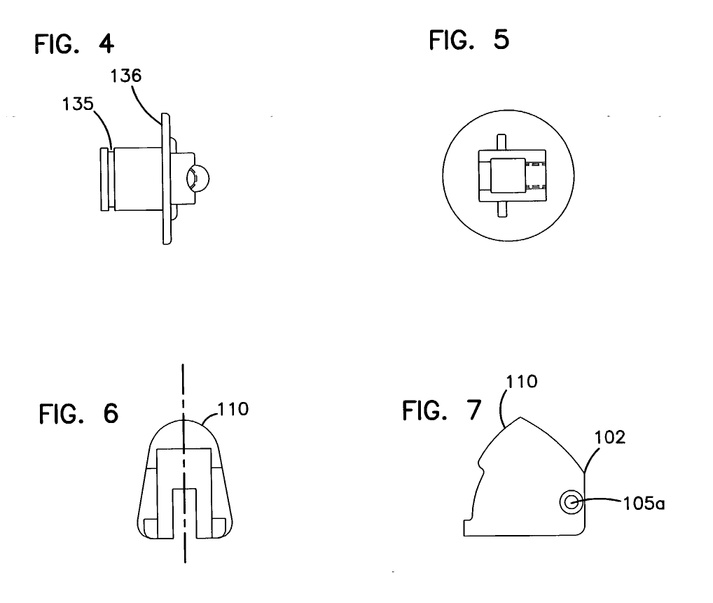

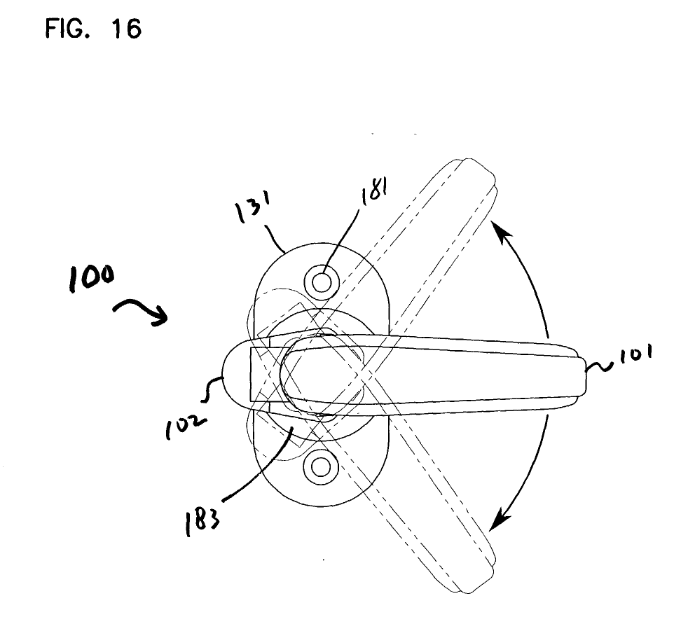

An exploded side view of the base assembly 130 is shown in FIG. 3. Base assembly 130 includes a turning axis hub 136 extending outward from the base assembly 130 and a snap ring groove 134 recessed in the base assembly 130. Base assembly 130 can be inserted into latch base 131 so that the turning axis hub 136 contacts the surface of latch base 131. Then, torsion spring 132 can be inserted over base assembly 130 past snap ring groove 134. Torsion spring 132 biases the rotation of the base assembly 130 in its inserted position relative to the latch base 131. Moreover, torsion spring 132 biases handle 101 in the relaxed position, shown as the solid line handle 101 in FIG. 16.

In a preferred embodiment, snap ring groove 134 is at least 0.05 inches (1.3 mm) in length. Turning axis hub 136 can preferably extend outward from the base assembly, to a diameter of at least 1.2 inches (30 mm). The base assembly 130 is most preferably at least 1 inch (25 mm) long when measured in its axial dimension. The portion of the base assembly 130, on the side of the turning axis hub 136 toward the snap ring groove 134 can preferably measure at least 0.5 inches (13 mm) along the axial dimension. Similarly, the portion of the base assembly 130, on the side of the turning axis hub 136 away from the snap ring groove 134 can preferably measure at least 0.3 inches (7.6 mm) along the axial dimension. The turning axis hub 136 can measure at least 0.05 inches (1.2 mm) along the axial dimension. The turning axis hub 136 should preferably be located at least 0.4 inches (10 mm) from the snap ring groove 134. The base assembly can preferably be manufactured from a wear resistant metal or thermoplastic material.

When a user exerts a rotational force against the handle 101 in a plane substantially parallel to the door surface, handle 101 moves to either the counterclockwise position 101′ or the clockwise position 101″. In a preferred embodiment, the counterclockwise position 101′ of the handle and the clock-wise position 101″ of the handle are less than 50° from the relaxed position of the handle 101, shown as a solid line on FIG. 16. The position of the latch nose 102 moves relative to the handle 101. When the handle 101 is in the counterclockwise position 101′ or clockwise position 101″, the latch nose is able to clear the strike 124 on the surface of the door frame 123, and the user is able to open the door 122. In a preferred embodiment, the latch nose 102 can clear the strike 124 when the latch nose is rotated less than 50° in response to a rotation of the handle 101.

Stator 133, shown in FIG. 11, is inserted over base assembly 130 so that it secures torsion spring 132 in place. Stator 133 contains at least one extension 136 that protrudes outward from stator 135. Extension 136 is useful for stabilizing stator 135 and torsion spring 132. In one embodiment, the ends of torsion spring 132 can catch in notch 136. Notch 136 provides a surface of resistance that is useful in biasing the torsion spring 132. Then, snap ring 135 is secured to snap ring groove 134 and locks the torsion spring 132 and stator 133 in place.

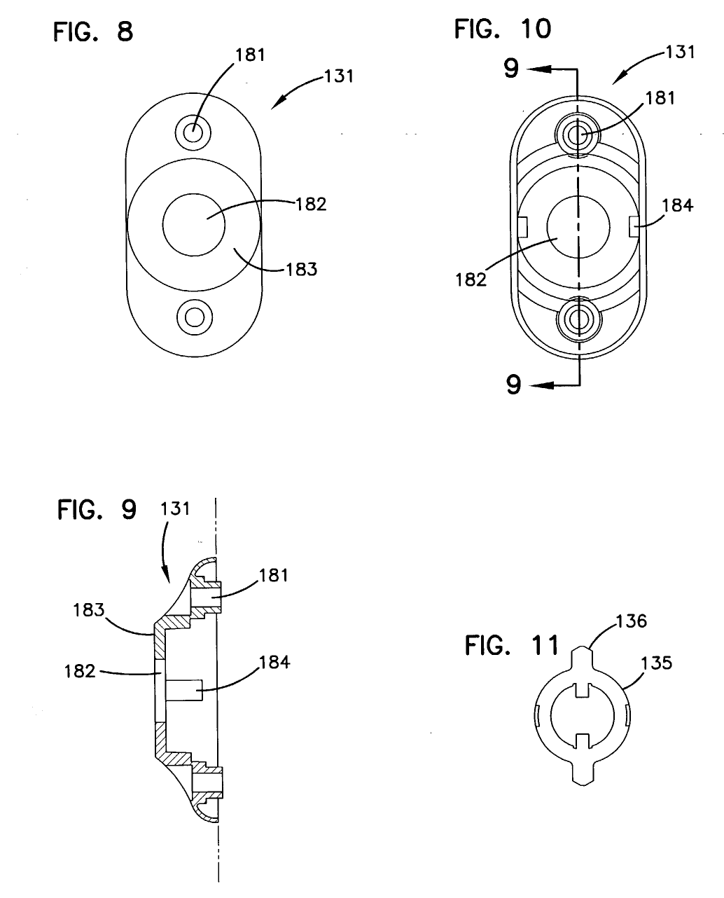

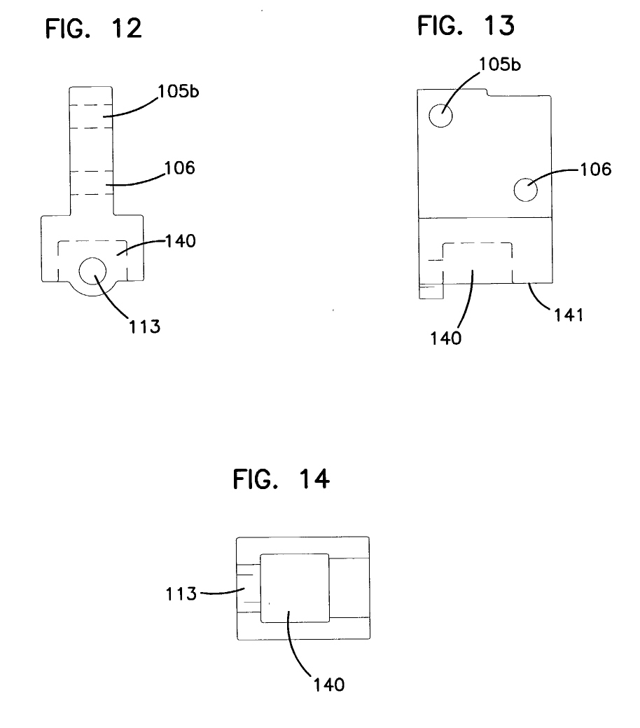

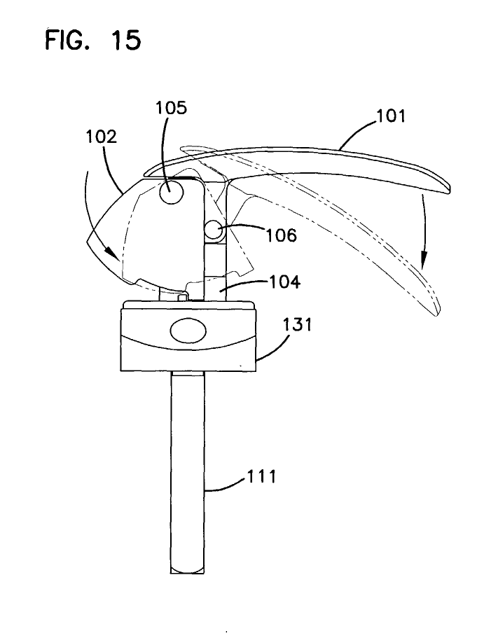

The latch base 131 is shown in FIGS. 8, 9, and 10. Latch base 131 contains a cavity 182 with a supporting ring 183 surrounding the cavity 182. The diameter of cavity 182 should be large enough so that base assembly 130 can pass there through, allowing turning axis hub 136 to contact supporting ring 183. Preferably, cavity 182 can be at least 0.59 inches (15 mm) in diameter. The outer portion of supporting ring 183 can preferably be at least 1.2 inches (30 mm) in diameter.

At least one mounting aperture 181 is located on the latch base 131 at a point adjacent to the supporting ring. Mounting aperture 181 should be large enough so that a fastener of suitable strength can pass there through. For example, mounting aperture 181 should preferably be at least 0.17 inches (4.3 mm) in diameter. The latch base 131 can be mounted to a door by inserting a fastener of suitable strength through the mounting aperture 181. In a preferred embodiment, the latch base 131 is mounted to a door by inserting screws through mounting apertures 181 and 182 so that they are tightly affixed to the door. Alternatively, the latch base 131 can be mounted to the door with adhesive. The shape of the latch base can vary considerably based on aesthetic considerations. Latch base 131 can include notch 184 that can provide a surface that is useful in preventing rotation of latch base 131 relative to spindle 110. In a preferred embodiment, notch 184 is at least 0.19 inches (4.8 mm) wide and 0.06 inches (1.5 mm) deep.

Spindle 110 of the latch assembly 100 can be inserted into the cavity 182 and through a similarly aligned aperture in the door so that the supporting ring 183 contacts the housing 104 and an end of the spindle 110 is exposed on the side of the door opposite the handle. A second latch base and second handle can then be slid over the exposed end of spindle 110 so that the latch nose 102 can be moved from both sides of the door.

FIG. 15 shows a first operable condition of the latch assembly 100 in which the latch nose 102 is moved by retracting the latch nose 102 in response to a force substantially normal to the door surface. The retracted position of the handle 101 and latch nose 102 are shown outlined in FIG. 15. The extended position of the handle 101 is substantially parallel to the surface of the door, and is shown with a solid outline on FIG. 15. In the extended position, the handle 101 makes contact with the latch nose 102 and biases the latch nose 102 toward the door. When the handle 101 is in the retracted position, the latch nose 102 is permitted to retract due to the force of the spring 103. In a preferred embodiment, the retracted position of the handle is less than 50° from the extended position of the handle.

A second operable condition of the latch assembly 100 is shown in FIG. 16. In the second operable condition, the latch nose 102 can be moved in response to a force in a plane substantially parallel to the door surface. The rotatable latch nose 102 and handle 101 position are shown outlined in FIG. 16. The user can rotate the handle 101 in either a clockwise or counterclockwise manner relative to the spindle 110. The rotation of the latch nose 102 corresponds to the rotation of the handle 101. When the user is not applying a force to the handle 101, torsion spring 132 biases the handle 101 and the latch nose 102 so that the latch nose 102 is located toward the strike on a door frame (shown as a solid line latch nose 102 on FIG. 16). In a preferred embodiment, the counterclockwise position of the handle and the clockwise position of the handle are less then 50° degrees from the relaxed position of the handle 101.

The above specification provides a complete description of the manufacture and use of the invention. Since many embodiments of the invention can be made without departing from the spirit and scope of the invention, the invention resides in the claims hereinafter appended.

We claim:

1. A door latching apparatus for maintaining a hinged door in a closed position by engaging a strike, wherein the latching apparatus is capable of being mounted on the surface of a door, the door latching apparatus comprising a latch nose and a handle, the latching apparatus configured such that a user can disengage latch nose from the strike by either the application of a rotational force to the handle in a plane either substantially parallel to the door surface or by the application of a force in a direction substantially normal to the door surface.

2. The door latching apparatus of claim 1 further comprising a spindle assembly configured to rotatably support the latch nose, wherein the latch nose is capable of retracting from an extended position away from the spindle assembly, to a position toward the spindle assembly.

3. The door latching apparatus of claim 2 further comprising a latch base suitable for operatively connecting the spindle assembly to the surface of a door, wherein the latch base is configured to allow rotation of the spindle assembly relative to the latch base when a force is applied to the spindle assembly in a plane substantially parallel to the door surface to retract the latch nose.

4. The door latching apparatus of claim 3, wherein the rotation of the spindle assembly is less than 50 degrees in a clockwise direction or counterclockwise direction.

5. The door latching apparatus of claim 1, further comprising a handle operatively connected to the latch nose, wherein the handle is configured for rotating the latch nose when a force is applied to the handle in a plane substantially parallel to the door surface and the handle is configured for moving the latch nose from an extended position to a retracted position when a force is applied to the handle in a plane substantially normal to the door surface.

6. The door latching apparatus of claim 6, wherein the latch nose is configured to rotate less than 50 degrees in the clockwise direction or the counterclockwise direction.

7. The door latching apparatus of claim 5, comprising a spring suitably engaged for biasing the latch nose toward the retracted position.

8. The door latching apparatus of claim 5, comprising a spring suitably engaged for biasing the handle in a plane parallel to the surface of the door.

9. The door latching apparatus of claim 5, wherein the handle is configured to displace the latch nose toward the extended position when the handle is in a plane parallel to the surface of the door.

10. The door latching apparatus of claim 2, wherein the spindle assembly further comprises a spindle head and a spindle, wherein the spindle is rigidly connected to the spindle head.

11. The door latching apparatus of claim 10, wherein the spindle assembly further comprises a base assembly including a torsion spring for biasing the latch nose in a substantially horizontal position.

12. The door latching apparatus of claim 3 further comprising a second latch base suitable for operatively connecting the second latch base to the door on the door's second surface.

13. The door latching apparatus of claim 12 further comprising a second handle operatively connected to the second latch base, wherein the second handle is capable of moving the latch nose away from the strike on the door frame.

14. The door latching apparatus of claim 18, wherein the second handle is capable of rotating less than 50 degrees relative to the latch base and wherein the second handle is also capable of rotating less than 30 degrees toward the surface of the door.

15. The door latching apparatus of claim 1, wherein the latch nose and spindle assembly are comprised of a metal composition or a thermoplastic material.

16. The door latching apparatus of claim 6, wherein the handle is comprised of a metal composition, a thermoplastic material, or a wood material.

17. A door latching apparatus mounted on a surface of a door, configured for maintaining a hinged door in a closed position, the latching apparatus comprising:
a latch nose,
a means to retract the latch nose in response to an axial force placed on the handle assembly, wherein the force is substantially normal to the door surface, and;
a means to retract the nose or nose assembly in response to a rotational force placed on the handle in a plane substantially parallel to the door surface.

18. The door latching apparatus of claim 17 further comprising a latch base suitable for fastening the latch base to the surface of a door.

19. The door latching apparatus of claim 18, wherein the latch base includes a means to attach the latch base to the door surface.

20. The door latching apparatus of claim 19, wherein the means to attach the latch base to the door surface includes an aperture in the latch base, wherein a fastener can be disposed through the aperture and extend into the door.

21. The door latch apparatus of claim 20, wherein the fastener is a threaded members.

22. The door latching apparatus of claim 19, wherein the means to attach the latch base to the door surface includes adhesive bonding the latch base and the door.

23. The door latching apparatus of claim 19, wherein the means to attach the latch base to the door includes a press fit between the latch base and the door.

24. The door latching apparatus of claim 18, wherein the latch base further comprises a rotatable handle assembly.

25. The door latching apparatus of claim 24, wherein the rotatable handle assembly is capable of rotating less than 50 degrees relative to the latch base.

26. The door latching apparatus of claim 24, wherein the rotatable handle assembly further comprises a latch nose.

27. The door latching apparatus of claim 26, wherein the latch nose is configured to contact a strike on a door frame and maintain the door in a closed position when the latch nose is in a substantially horizontal position.

28. The door latching apparatus of claim 27, wherein the latch nose rotates in response to a force placed on the rotatable handle assembly in a direction substantially parallel to the surface of a door.

29. The door latching apparatus of claim 27, wherein the latch nose rotates less than 50 degrees from the substantially horizontal position.

30. The door latching apparatus of claim 27, wherein the latch nose rotates in response to a force placed on the rotatable handle assembly in a direction substantially normal to the surface of a door.

31. The door latching apparatus of claim 27, wherein the rotatable handle assembly further comprises a torsion spring to bias the rotatable handle assembly to maintain the latch nose in a substantially horizontal position.

32. The door latching apparatus of claim 27, wherein the rotatable handle assembly further comprises a spring to bias the latch nose toward the rotatable handle assembly.

33. The door latching apparatus of claim 32, wherein the rotatable handle assembly further comprises a handle capable of moving from an extended position to a retracted position in response to a force substantially normal to the surface of a door.

34. The door latching apparatus of claim 33, wherein the rotatable handle assembly further comprises a spring suitable for biasing the handle in an extended position.

35. The door latching apparatus of claim 34, wherein the handle is configured to displace the latch nose away from the rotatable handle assembly when the handle is in the extended position.

36. The door latching apparatus of claim 33, wherein the retracted position of the handle is at least 20 degrees from the extended position of the handle.

37. The door latch apparatus of claim 17, wherein the means to retract the latch nose in response to a substantially normal force placed on the handle assembly includes a spring with a first end and a second end, wherein the first end of the spring is fastened to the latch nose and the second end of the spring is fastened to the rotatable handle assembly, whereby the displacement of the handle assembly allows the latch nose to retract due to the force of the spring.

38. The door latch apparatus of claim 17, wherein the means to rotate the latch nose in response to a substantially parallel force placed on the handle assembly includes a spring located in the rotatable handle assembly, wherein the spring biases the latch nose toward a strike on a door frame and enables the user to rotate the handle in a clockwise pattern relative to the latch base such that the latch nose also rotates in a clockwise pattern away from the strike.

39. The door latch apparatus of claim 17, wherein the means to rotate the latch nose in response to a substantially parallel force placed on the handle assembly includes a spring located in the rotatable handle assembly, wherein the spring biases the latch nose toward a strike on a door frame and enables the user to rotate the handle in a counterclockwise manner relative to the latch base such that the latch nose also rotates in a counterclockwise pattern away from the strike.

40. The door latch apparatus of claim 27, wherein the latching apparatus further comprises a second handle configured to move the latch nose.

41. A door capable of being hingedly attached to a frame, the door comprising:
a latching apparatus for maintaining an openable door in a closed position when the latching apparatus is in contact with a strike on the door frame, the latching apparatus being capable of opening the door with either a force applied to the latching apparatus that is substantially normal to the door surface or a rotating force applied to the latching apparatus in a plane substantially parallel to the door surface, the latching apparatus comprising:
a means to disengage the latching apparatus from the strike in response to a force placed on the handle assembly substantially normal to the door surface, and,
a means to disengage the latching apparatus from the strike in response to a force applied to the handle assembly in a plane substantially parallel to the door surface,

42. The door of claim 41, wherein the latching apparatus further comprises a latch nose that contacts the strike to maintain the door in a closed position.

43. The door of claim 41, wherein the latching apparatus further comprises a rotatable handle assembly,

44. The door of claim 41, wherein the latch nose is capable of disengaging from the strike by rotating less than 50 degrees from the horizontal axis.

45. The door of claim 41, wherein the latch nose is capable of disengaging from the strike by pivoting at least 5 degrees towards the latch base.

46. The door of claim 41, wherein the latch nose is capable of disengaging from the strike by pivoting at least 10 degrees towards the latch base.

47. The door of claim 41, wherein the door is at least partially comprised of a wood material.

48. The door of claim 41, wherein the door is at least partially comprised of a metallic material.

49. The door of claim 41, wherein the door is at least partially comprised of a thermoplastic material.

50. The door of claim 54, further comprising a frame, wherein the door is hingedly attached to the frame.

51. The door of claim 41, wherein the door is about 0.25 inches (0.6 cm) to less than 2 inches (5 cm) thick and comprises an all season door.
